(19) United States
(12) Patent Application Publication
(10) Pub. No.: US 2016/0156381 A1
(43) Pub. Date: Jun. 2, 2016

(54) LEAKAGE CANCELLATION A MULTIPLE-INPUT MULTIPLE-OUTPUT TRANSCEIVER

(71) Applicant: TELEFONAKTIEBOLAGET L M ERICSSON (PUBL), Stockholm (SE)

(72) Inventors: Mats RYDSTRÖM, Billdal (SE); Mikael COLDREY, Landvetter (SE); Ola TAGEMAN, Göteborg (SE)

(73) Assignee: Telefonaktiebolaget L M Ericsson (publ), Stockholm (SE)

(21) Appl. No.: 14/897,059

(22) PCT Filed: Jun. 18, 2013
(86) PCT No.: PCT/EP2013/062608

§ 371 Date: Dec. 9, 2015

(51) Int. Cl. H04B 1/525; H04B 7/04; H04L 5/14; H04B 1/10

(52) U.S. Cl. CPC H04B 1/525; H04B 1/10; H04B 7/0413; H04L 5/14

(57) ABSTRACT

A transceiver 100 for simultaneous transmission and reception of communication signals in a multiple-input multiple-output, MIMO, system allowing operation on at least partly overlapping frequency bands. The transceiver 100 comprising an antenna arrangement 110, a duplex arrangement 120, and a modem unit 130. The duplex arrangement 120 being adapted to forward a transmit signal T1 from the modem unit to the antenna arrangement 110. The duplex arrangement 120 also being adapted to receive a receive signal R1 from the antenna arrangement 110 and to forward an interference suppressed receive signal R2 to the modem unit. The duplex arrangement 120 comprising an interference cancellation unit adapted to generate the interference suppressed receive signal R2 by combining the receive signal R1 from the antenna arrangement and the transmit signal T1.

### TECHNICAL FIELD

The present disclosure relates to a transceiver and a method for simultaneous transmission and reception of communication signals in a multiple-input multiple-output, MIMO, system.

### BACKGROUND

Spectral efficiency is a measure of the efficiency of a communication system in communicating information bits between transceivers using a limited frequency resource. Spectral efficiency is often measured in units of transmitted information bits per second and Hertz of occupied bandwidth, bits/sec/Hz for short.

Communication systems based on multiple-input multiple-output, MIMO, transceivers have the potential to reach a spectral efficiency beyond that possible to reach by using single-input single-output, SISO, transceivers. In a SISO system, only a single information stream can be transmitted via the communication channel between transmitter and receiver, whereas, in a MIMO system, more than one information stream can be multiplexed onto, or transmitted via, the multi-dimensional MIMO communication channel between transmitter and receiver.

There is an ever growing need for capacity. To increase capacity, more antennas can be added to the MIMO antenna arrangement, in order to increase the dimensionality of the MIMO communication channel, and thus potentially also the spectral efficiency. However, the addition of more antennas to a MIMO system can be costly, especially in microwave radio link applications and the like where antenna installation can be cumbersome and where antenna hardware is often expensive.

Consequently, there is a need to improve the spectral efficiency in MIMO communication systems without adding additional antennas to the existing MIMO antenna arrangement.

### SUMMARY

An object of the present disclosure is to provide a transceiver for simultaneous transmission and reception of communication signals in a multiple-input multiple-output, MIMO, system which seeks to mitigate, alleviate, or eliminate one or more of the above identified deficiencies in the art and disadvantages singly or in any combination and to provide an improved MIMO transceiver.

This object is obtained by a transceiver for simultaneous transmission and reception of communication signals in a MIMO system. The transceiver comprises an antenna arrangement, a duplex arrangement, and a modem unit. The duplex arrangement is adapted to receive a transmit signal from the modem unit, and to transmit a first part of the transmit signal to the antenna arrangement. The duplex arrangement is further adapted to receive a receive signal from the antenna arrangement. The duplex arrangement also comprises an interference cancellation unit, IC, which is adapted to generate an interference suppressed receive signal by combining the receive signal and the transmit signal. The duplex arrangement is further adapted to transmit the interference suppressed receive signal to the modem unit.

Since the MIMO transceiver disclosed herein comprises a duplex arrangement with interference cancelling features, the MIMO transceiver is able to improve reception conditions and thus also reach higher spectral efficiencies compared to a system without said interference suppressing features.

According to an aspect, the receive signal occupies a first frequency band and the first part of the transmit signal occupies a second frequency band. Further, the first and second frequency bands are at least partly overlapping. The transceiver is thus arranged to simultaneously transmit and receive communication signals in a MIMO system on at least partly overlapping frequency bands.

Since the MIMO transceiver disclosed herein is able to both transmit and receive on the same frequencies, the available bandwidth is more efficiently used compared to a system which transmits and receives on separated frequencies. Hence, since a transceiver of the present disclosure is arranged to simultaneously transmit and receive signals in a MIMO system on at least partly overlapping frequency bands, the spectral efficiency of a MIMO system utilizing said transceiver is increased compared to a MIMO system without such a transceiver, i.e., a transceiver which transmits and receives simultaneously in non-overlapping frequency bands. In some systems the spectral efficiency will be doubled, as frequencies previously used for only transmission or reception now is used for both transmission and reception simultaneously, thus doubling the available MIMO system bandwidth.

It is noted that said increase in spectral efficiency of the MIMO system can be obtained without the addition of more antennas, i.e., said increase in spectral efficiency does not originate from a spatial multiplexing gain as in conventional MIMO systems, but from a more efficient utilization of available frequency resources in that transmission and reception can take place simultaneously in at least partly overlapping frequency bands.

According to an aspect the antenna arrangement is part of a Line Of Sight, LOS, multiple-input multiple output, MIMO, antenna arrangement. The transmit and receive signals then comprises a plurality of data streams, arranged to be transmitted over a plurality of LOS-MIMO channels.

Consequently, the spectral efficiency of a LOS-MIMO system can be increased without the addition of more antennas, if the LOS-MIMO system is instead arranged to transmit and receive signals in at least partly overlapping frequency bands according to the present disclosure.

According to an aspect the transceiver of the present disclosure is further adapted for transmission and reception of microwave radio link communication signals.

Hence, an embodiment of the present disclosure comprises a LOS-MIMO microwave radio link which is arranged to transmit and receive simultaneously on at least partly overlapping frequency bands, thus providing an increased spectral efficiency compared to a LOS-MIMO microwave radio link transmitting and receiving on separated frequencies.

According to an aspect the interference cancellation unit comprises at least one duplex coupler arranged to connect the antenna arrangement to at least one modulator and at least one demodulator comprised in the modem unit. The duplex coupler is arranged to forward part of the transmit signal from the at least one modulator to the antenna arrangement as the first part of the transmit signal, and also to forward the receive signal from the antenna arrangement to the at least one demodulator as the interference suppressed receive signal, wherein the interference suppressed receive signal is arranged to be isolated from the transmit signal.

A key benefit of the duplex coupler is that it provides isolation between the transmit signal and the interference suppressed receive signal. Thus the interference suppressed receive signal will not contain an excessive amount of interference originating from the transmit signal. Another beneficial feature of the duplex coupler is that it communicatively couples a modulator and a demodulator comprised in the modem unit with the antenna arrangement.

According to an aspect the interference cancellation unit comprises a set of adaptive filters arranged to receive and to filter a second part of the transmit signal received from the modem unit to generate a set of filtered transmit signals. The interference cancellation unit is also adapted to combine the receive signal received from the antenna arrangement with the set of filtered transmit signals to generate the interference suppressed receive signal. The set of adaptive filters are arranged to have transfer functions determined by a control signal. The transceiver also comprises a control unit which is adapted to generate a control signal arranged to determine the transfer functions of the set of adaptive filters. The control signal has a setting which reduces the power of an interference signal comprised in the interference suppressed receive signal, which interference signal originates at least in part from the transmit signal.

According to an aspect, the second part of the transmit signal arranged to be received from the modem unit by the set of adaptive filters is arranged to be received via the duplex coupler.

A benefit of said adaptive filters is that the transceiver is able to suppress an interference signal, originating from the transmit signal, in the interference suppressed receive signal, even though said interference signal is not an exact copy of the transmit signal but a function, e.g., a linear function, of the transmit signal.

Additionally, any noise and distortion present in the transmit signal and leaking into said interference signal is also handled by the disclosed system. Examples include noise added by a power-amplifier in the system, and non-linearities caused by non-linear components in the transmit chain.

According to an aspect, the control unit is adapted to generate the control signal to control the transfer functions of the set of adaptive filters such as to minimize the magnitude of the correlation between the transmit signal and the interference suppressed receive signal.

A benefit of the control unit mentioned above is that an interference signal which originates from the transmit signal, which interference signal is characterized by a function of the transmit signal, can be suppressed in the interference suppressed receive signal even though said function of the transmit signal is time varying, i.e., the function evolves over time.

According to an aspect the duplex arrangement comprises a polarization diplexer connected to the antenna arrangement. The polarization diplexer being arranged to receive the receive signal from the antenna arrangement, and to split the receive signal into horizontal and vertical receive components, as well as to output horizontal and vertical receive components on horizontal and vertical polarization ports as first and second receive signals, respectively. The horizontal and vertical polarization ports being connected to first and second interference cancellation units, respectively. The first interference cancellation unit is adapted to receive a first transmit signal and a second transmit signal from the modem unit and to forward a first part of the first transmit signal to the horizontal polarization port. The second interference cancellation unit is adapted to receive the first transmit signal and the second transmit signal from the modem unit and to forward a first part of the second transmit signal to the vertical polarization port. The first interference cancellation unit is adapted to receive the first receive signal from the horizontal polarization port and to suppress an interference signal comprised in the first receive signal by processing and combining the first and second transmit signal with the first receive signal to generate a first interference suppressed receive signal. The second interference cancellation unit is adapted to receive the second receive signal from the vertical polarization port and to suppress an interference signal comprised in the second receive signal by processing and combining the first and second transmit signal with the second receive signal to generate a second interference suppressed receive signal. The first and second interference cancellation units are further adapted to forward the first and second interference suppressed receive signals to the modem unit, respectively.

According to an aspect the polarization diplexer comprises an orthomode transducer, OMT.

According to an aspect the antenna arrangement comprises first and second antenna units disposed a pre-determined distance apart. The duplex arrangement also comprises first and second interference cancellation units. The first and second interference cancellation units are adapted to receive a first transmit signal and a second transmit signal, respectively, from the modem unit. The first interference cancellation unit is adapted to forward a first part of the first transmit signal to the first antenna unit. The second interference cancellation unit is adapted to forward a first part of the second transmit signal to the second antenna unit. The first interference cancellation unit is adapted to receive a first receive signal from the first antenna unit and to suppress an interference signal comprised in the first receive signal by processing and combining the first transmit signal with the first receive signal, to generate a first interference suppressed receive signal. The second interference cancellation unit is adapted to receive a second receive signal from the second antenna unit and to suppress an interference signal comprised in the second receive signal by processing and combining the first transmit signal with the second receive signal to generate a second interference suppressed receive signal. The first and second interference cancellation units are further adapted to forward the first and second interference suppressed receive signals to the modem unit, respectively. The interference signals mentioned above originates from the first and second transmit signal.

According to an aspect the first and second interference cancellation units are arranged to receive also the second and the first transmit signal, respectively, and to suppress an interference signal by processing and combining the second transmit signal with the first receive signal and the first transmit signal with the second receive signal, respectively, to generate the first and the second interference suppressed receive signal, respectively.

According to an aspect, the first part of the transmit signal arranged to pass from the duplex arrangement to the antenna arrangement, and the receive signal arranged to pass from the antenna arrangement to the duplex arrangement share the same physical interface of the antenna arrangement.

According to an aspect, the first part of the transmit signal arranged to pass from the duplex arrangement to the antenna arrangement and the receive signal arranged to pass from the antenna arrangement to the duplex arrangement are transmitted and received via separate physical interfaces to the antenna arrangement.

According to an aspect, the antenna arrangement comprises first and second antenna units disposed a pre-determined distance apart. The first and second antenna unit is arranged to have directive radiation patterns focused in a first and a second pre-determined direction. The IC unit is adapted to combine the transmit signal and the receive signal by forwarding the transmit signal to the first antenna and forwarding a receive signal received at the second antenna unit from the second antenna unit to the modem unit, wherein said combining is via signal propagation of the transmit signal from the first antenna to the second antenna.

Consequently, the first and second antenna units are configured to attenuate a transmit signal propagating from the first to the second antenna unit, thus suppressing an interference originating from the transmit signal in the interference reduced receive signal. According to this aspect, the IC unit is configured to correctly forward transmit and receive signals between modem unit and antenna arrangement, and consequently comprise little complexity as the combining of transmit and receive signal is facilitated by the IC unit using propagation between first and second antenna units.

A further object of the present disclosure is to provide a method for transmission and reception of communication signals in a MIMO system which seeks to mitigate, alleviate, or eliminate one or more of the above-identified deficiencies in the art and disadvantages singly or in any combination. This further object is obtained by a method for the transmission and reception of communication signals in partly overlapping frequency bands in a multiple-input multiple output, MIMO, system. The method comprises the steps of receiving a transmit signal from a modem in a duplex arrangement, and forwarding, from the duplex arrangement, a first part of said transmit signal to an antenna arrangement. The method also comprises the steps of receiving, in the duplex arrangement, a receive signal from the antenna arrangement, and suppressing an interference signal comprised in the receive signal by combining the receive signal and the transmit signal to generate an interference suppressed receive signal, which interference signal originates from the transmit signal, the interference suppressed receive signal occupying a first frequency band, the first part of the transmit signal occupying a second frequency band, the first and second frequency bands being at least partly overlapping. The method further comprises the step of forwarding the interference suppressed receive signal from the duplex arrangement to the modem.

Hence, since interference in the receive signal originating from the transmit signal is suppressed in the interference suppressed receive signal, the first part of the transmit signal and the receive signal can occupy at least partly overlapping frequency bands without causing excessive interference in the interference suppressed receive signal. This increases the spectral efficiency of the MIMO system since bands previously used for transmit only or receive only can now be used for both transmit and receive signals at the same time, and at the same side of a radio link hop, by a transceiver implementing the present method.

According to an aspect the step of suppressing further comprises the step of filtering by a set of adaptive filters arranged to receive and to filter a second part of the transmit signal to generate a set of filtered signals. The step of suppressing also comprises the step of combining the receive signal with the set of filtered signals to generate an interference suppressed receive signal.

According to an aspect the set of adaptive filters are arranged to have transfer functions determined by a control signal, and the step of suppressing further comprises controlling the transfer functions of the adaptive filters by the control signal to reduce interference in the interference suppressed receive signal originating from the transmit signal.

According to an aspect, controlling the transfer functions of the adaptive filters by the control signal comprises determining a control signal to minimize the correlation between transmit signal and interference suppressed receive signal.

According to an aspect the duplex arrangement comprises a polarization diplexer adapted to split a received dual-polarized signal into horizontal and vertical components prior to the step of suppressing, and to combine horizontal and vertical transmit components into a single dual-polarized transmit signal prior to the step of forwarding the first part of the transmit signal to the antenna arrangement.

According to an aspect the antenna arrangement comprises first and second antenna units disposed a pre-determined distance apart. The step of suppressing then comprises isolating the interference suppressed receive signal from the transmit signal by using first and second interference cancellation units. The first and second interference cancellation units are adapted to receive a first and a second transmit signal from the modem, respectively. The first and second interference cancellation units are further adapted to forward a first part of the first and a first part of the second transmit signal, respectively, to the first and second antenna units, respectively. The first and second interference cancellation units are also adapted to receive a first and a second receive signal, respectively, from the first and second antenna units, respectively, and to isolate the first and second receive signal from the first and second transmit signal, respectively, prior to forwarding said isolated receive signals to the modem unit as first and second interference suppressed receive signals, respectively.

### BRIEF DESCRIPTION OF THE DRAWINGS

Further objects, features, and advantages of the present disclosure will appear from the following detailed description, wherein some aspects of the disclosure will be described in more detail with reference to the accompanying drawings, in which:

FIG. 1-2 are block diagrams showing embodiments of a transceiver, and

FIG. 3 schematically shows an interference cancellation unit, and

FIG. 4 schematically shows a dual polarization transceiver, and

FIG. 5 schematically shows a transceiver with two antennas, and

FIG. 6 schematically shows an interference cancellation unit, and

FIG. 7 is a flowchart illustrating an embodiment of a method of the disclosure.

### DETAILED DESCRIPTION

Aspects of the present disclosure will be described more fully hereinafter with reference to the accompanying drawings. The apparatus and method disclosed herein can, however, be realized in many different forms and should not be construed as being limited to the aspects set forth herein. Like numbers in the drawings refer to like elements throughout.

The terminology used herein is for the purpose of describing particular aspects of the disclosure only, and is not intended to limit the disclosure. As used herein, the singular forms “a”, “an” and “the” are intended to include the plural forms as well, unless the context clearly indicates otherwise.

Two wirelessly connected transceivers are herein referred to as near end and far end transceivers. In order for a near end transceiver to receive and successfully detect a payload signal comprised in a signal transmitted from a far end transceiver, the receive signal prior to detection must be reasonably clean from interference, as such interference will limit the capacity of the system and thus also the spectral efficiency. A main purpose of the transceiver receive chain is to suppress interference and noise in the received signal as far as possible, in order to make a reliable detection of the payload signal possible at high spectral efficiency.

The transmit signal of the near end transceiver can be expected to be very strong, i.e., to have a large power, compared to the often very weak receive signal which has propagated over the air from the far end transceiver, and therefore has been attenuated. Should part of the transmit signal leak into the receive signal, strong interference will result and cause degradation in detection performance. The comparably weak receive signal therefore needs to be protected from the comparably strong transmit signal.

One way to protect the receive signal from the transmit signal is to separate transmission and reception in time. This scheme is called time division duplex, TDD. TDD utilizes the total available system bandwidth part of the time for transmission in one direction, and part of the time for transmission in the other direction. Thus, compared to a system which utilizes the total available system bandwidth for transmission in all directions all of the time, it is not preferred, at least from a spectral efficiency point of view.

An alternative to TDD is to transmit on one set of frequencies, a transmit frequency band, and receive on another set of frequencies, a receive frequency band. This scheme is known as frequency division duplex, FDD. Since transmit and receive signals are separated in frequency, interference from the transmit signals on the receive signals can be prevented or suppressed by means of passive filtering, e.g., by applying band-pass channel filters to separate transmit and receive signals.

It should be noted that it is not only the transmit signal itself that causes interference in the receive signal, but also noise generated by the transmit chain, e.g., wide-band noise generated by a transmit chain power amplifier. Consequently, having isolation between transmit and receive signal is motivated also by the need to suppress such transmit chain noise and distortion.

Herein, simultaneous transmission and reception of communication signals refers to parallel transmission and reception taking place at the same time, as in an FDD-based system, and not as in a system which alternates between transmission and reception over time.

However, as will be shown below through various embodiments of the present disclosure, interference from transmit signals on receive signals can be prevented by interference cancellation techniques other than traditional passive filtering. These interference cancellation techniques are effective even if transmit and receive signals are not separated in frequency.

Hence, it becomes possible to, e.g., transmit and receive on overlapping frequency bands. The available spectrum is then more efficiently utilized since the available bandwidth is used for both transmission and reception at the same time, as opposed to only being used for transmission, or for reception, at any given instant in time.

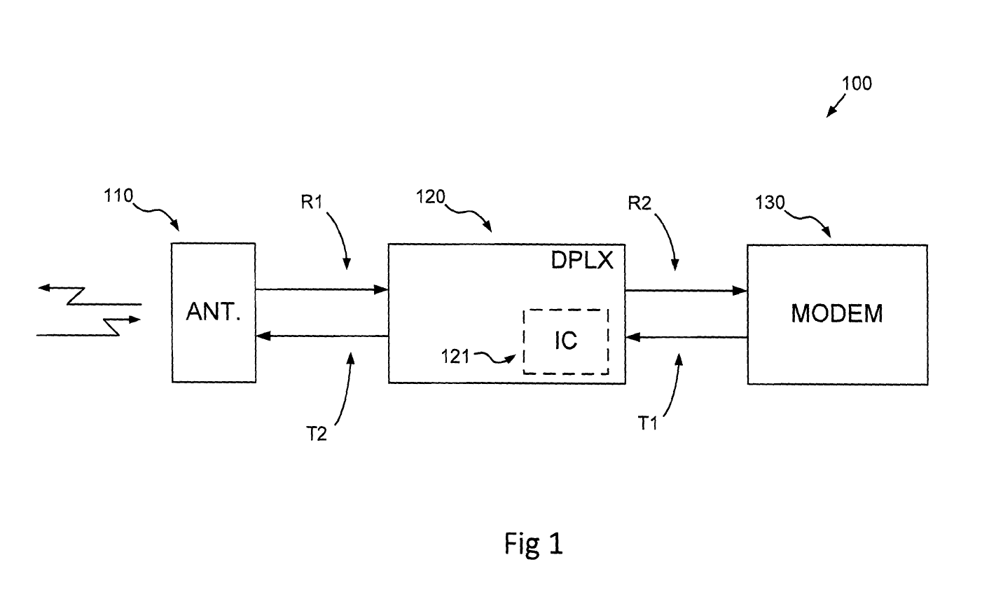

FIG. 1 shows a transceiver 100 for simultaneous transmission and reception of communication signals in a multiple-input multiple-output, MIMO, system. The transceiver 100 comprises an antenna arrangement 110, a duplex arrangement 120, and a modem unit 130.

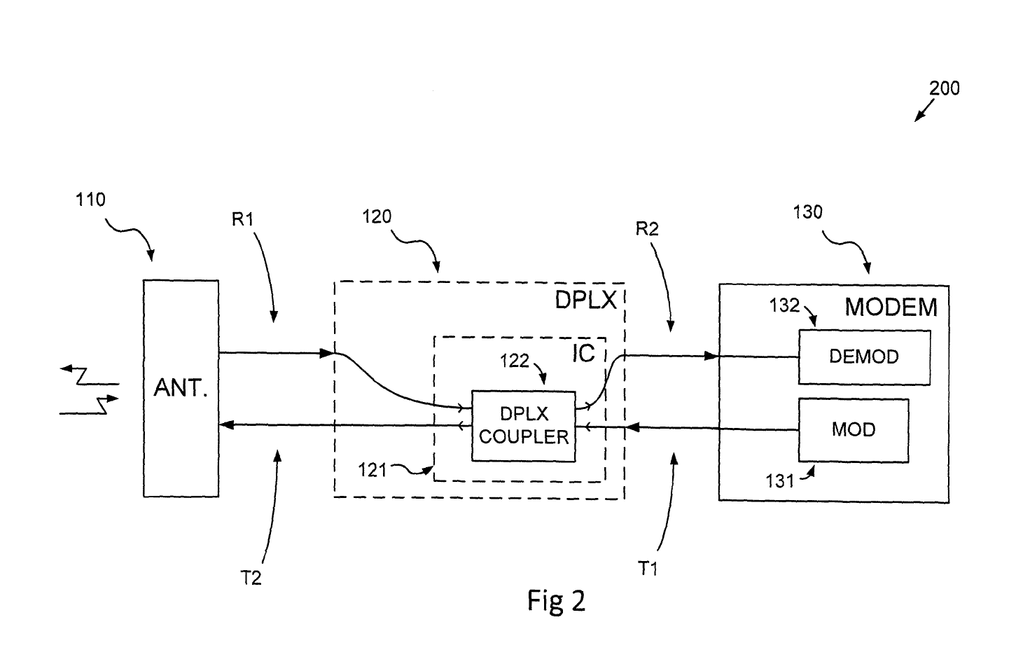

By modem unit 130 is here meant a unit which comprises a modulator device 131 and a demodulator device 132, as shown in FIG. 2. Thus, the modem unit 130 is adapted to generate a transmit signal T1 by modulating a payload signal, and also detect an payload signal in a received signal, shown in FIG. 1 as an interference suppressed receive signal R2, by demodulating the received signal.

By antenna arrangement 110 is here meant an arrangement for the transmission and reception of wireless signals over a shared transmission medium such as air. The antenna arrangement 110 can comprise any number of antennas and also antennas of varying types, e.g., disc antennas, horn antennas, and antenna arrays, as well as di-pole antennas and the like. The antennas can be of dual polarization type, or of single polarization type.

By duplex arrangement 120 is here meant an arrangement adapted to connect transmit and receive ports of a modem unit 130 to an antenna arrangement 110 for transmission and reception of wireless signals. A purpose of the duplex arrangement 120 is to facilitate transmission and reception of signals R1, T2, using a common antenna arrangement 110 for both transmission and reception. Another purpose of the duplex arrangement 120 is to isolate transmit signal T1 from an interference suppressed receive signal R2.

By isolate is here meant avoiding that the transmit signal T1 leaks into the interference suppressed receive signal R2 during transceiver operation, such that signals stemming from the transmit signal T1, or stemming from components in the transmit chain of the transceiver, do not enter the interference suppressed receive signal R2 as interference components. In order to achieve this separation, or isolation, the present disclosure applies the technique of combining transmit T1 and receive signal R1 in a controlled manner, such that interference, i.e., artefact components originating from the transmit signal T1 comprised e.g. in the receive signal R1, are suppressed in the interference suppressed receive signal R2. Thus, isolating should here not be construed as no part of the transmit signal T1 enters the interference suppressed receive signal R2. Instead, a controlled part of the transmit signal T1 is combined with the receive signal R1 in order to cancel out already present components of the transmit signal T1 in the interference suppressed receive signal R2.

It should be noted that there can be a set of unwanted contributions from the transmit signal T1 in the interference suppressed receive signal R2. Such unwanted contributions can arise due to imperfections in the antenna arrangement, e.g., in wave-guide connections, antenna feeder, antenna reflector, antenna surrounding. However, said unwanted contributions can also arise already within the duplex arrangement due to imperfections in the duplex arrangement. A key idea of the present technique is to cancel the sum of such contributions, regardless where they arise, by deliberate addition of a processed version of the transmit signal T1 to the receive signal R1 to generate the interference suppressed receive signal R2.

The embodiment of the duplex arrangement 120 shown in FIG. 1 is connected between the antenna arrangement 110 and the modem unit 130, providing a two-way communication conduit between modem unit 130 and antenna arrangement 110. The duplex arrangement 120 is adapted to receive a transmit signal T1 from the modem unit. The transmit signal is then split in parts, where a first part of the transmit signal T2 is transmitted to the antenna arrangement 110. The duplex arrangement 120 is also adapted to receive a receive signal R1 from the antenna arrangement 110. According to an aspect this receive signal R1 comprises a payload signal transmitted from at least one other transceiver in the communication system.

The receive signal R1, which was captured at the antenna arrangement 110, also comprises a plurality of interference and noise components. Examples of such interference and noise components include co-channel interference, self-interference originating from the transmit signal T1, and thermal noise.

A key aspect of the duplex arrangement 120 is that it comprises an interference cancellation unit, IC, 121. This interference cancellation unit 121 is adapted to generate an interference suppressed receive signal R2 by combining the receive signal R1 and the transmit signal T1. The duplex arrangement 120 is also adapted to transmit the interference suppressed receive signal R2 to the modem unit 130.

Another key concept of the present disclosure lies in the fact that, since the transmit signal T1 is known or can be measured, an interference in the receive signal R1, or in the interference suppressed receive signal R2, which originates at least in part in some deterministic manner from the transmit signal T1 can be suppressed or cancelled out, since the signal is known at the transceiver. Interference originating from the transmit signal T1 is therefore not the same as, e.g., additive white thermal noise, since it can be suppressed by an interference cancellation unit arranged to process the receive signal R1 and the known transmit signal T1 to make an interference suppressed receive signal R2.

According to an aspect, the transmit signal T1 which is combined with the receive signal R1 not only comprises the modulated signal generated by the modulator of the modem unit, but also comprises other interference and noise components added by components of the transceiver transmit chain. Examples of such other components are thermal noise and intermodulation products added by amplifier and mixer devices.

An increase in spectral efficiency as compared to a traditional MIMO transceiver which transmits and receives on separated frequencies is obtained since, according to aspects of the transceiver 100 of the present disclosure, the receive signal R1 occupies a first frequency band, and the first part of the transmit signal T2 occupies a second frequency band, where the first and second frequency bands are at least partly overlapping. Aspects of the transceiver 100 of the present disclosure is thus arranged to simultaneously transmit and receive communication signals in a MIMO system on at least partly overlapping frequency bands.

In an embodiment, the transceiver 100 comprises a first bandpass filter, not shown in FIG. 1, arranged to limit the bandwidth of the first part of the transmit signal T2 transmitted from the antenna arrangement 110, as a contribution to the spectrum shaping of the transmit signal T2 such that it agrees with, e.g., a transmission mask of a transmission license of the transceiver 100.

According to an aspect the transceiver 100 also comprises a second bandpass filter, not shown in FIG. 1, arranged to limit the bandwidth of the receive signal R1, such that the receive signal R1 does not comprise an excessive amount of, e.g., noise and co-channel interference. Since the first and second frequency bands mentioned above are at least partly overlapping, it follows that also the first and second band-pass filters have pass-bands which are at least partly overlapping.

Of particular importance and benefit is the fact that the interference cancellation unit is comprised in the duplex arrangement 120, as opposed to only being comprised in the modem unit 130, which modem unit 130 is commonly implemented in the digital domain. The reason being that the transmit signal T1, and the first part of the transmit signal T2 can be expected to be very strong, i.e., to have a large power, compared to the receive signal R1 which has propagated over the air and therefore has been attenuated. In order to perform interference cancellation in a digital modem unit the combination of strong interference signal and weak receive signal must be converted from analog to digital domain. Hence, the strong transmit signal T1 will impose high requirements on the resolution of the analog to digital converter, in order not to add significant quantization noise to the received signal R1.

In an embodiment, additional interference suppression devices and arrangements are comprised in the modem unit 130, following initial interference suppression by the interference cancellation unit comprised in the duplex arrangement 120.

In an embodiment, the antenna arrangement 110 shown in FIG. 1 is part of a Line Of Sight, LOS, MIMO antenna arrangement. The communication signals transmitted and received then comprise a plurality of data streams, arranged to be transmitted over a plurality of LOS-MIMO channels.

According to an aspect the communication signals are microwave radio link communication signals.

Hence, aspects of the present disclosure will increase the spectral efficiency of a LOS-MIMO microwave radio link without adding additional antennas to the installation.

FIG. 2 shows a transceiver 200 for simultaneous transmission and reception of communication signals in a multiple-input multiple-output, MIMO, system. In the embodiment shown in FIG. 2, the interference cancellation unit 121 comprised in the duplex arrangement 120 comprises a duplex coupler 122 arranged to connect the antenna arrangement 110 to at least one modulator 131 and at least one demodulator 132 in the modem unit 130. The duplex coupler 122 is arranged to forward a part of the transmit signal T1 from the at least one modulator to the antenna arrangement 110 as the first part of the transmit signal T2, and also to forward a receive signal R1 from the antenna arrangement 110 to the at least one demodulator as an interference suppressed receive signal R2.

A purpose of the duplex coupler 122 is to provide a signal conduit between modem unit 130 and antenna arrangement 110. The duplex coupler also provides a degree of isolation between transmit signal T1 and interference suppressed receive signal R2. It should be noted that the duplex coupler also isolates the interference suppressed receive signal R2 from wide-band noise in the transmit chain of the transceiver 100, 200.

According to an aspect, the antenna arrangement 110″ further comprises first 115 and second 116 antenna units disposed a pre-determined distance apart. The first 115 and second 116 antenna unit is arranged to have directive radiation patterns focused in a first and a second pre-determined direction. The IC unit 121 is, according to said aspect, adapted to combine the transmit signal T1 and the receive signal R1 by forwarding the transmit signal T1 to the first antenna 115 and forwarding a receive signal R1 received at the second antenna unit 116 from the second antenna unit 116 to the modem unit 130, wherein said combining is via signal propagation of the transmit signal from the first antenna 115 to the second antenna 116.

Consequently, since antenna units 115, 116 are disposed a pre-determined distance apart and are arranged to have directive radiation patterns focused in a first and a second pre-determined direction, isolation between transmit signal and receive signal is achieved. Said combining by the interference cancellation unit 121 here merely constitutes a forwarding of transmit signal and receive signal in a pre-determined direction.

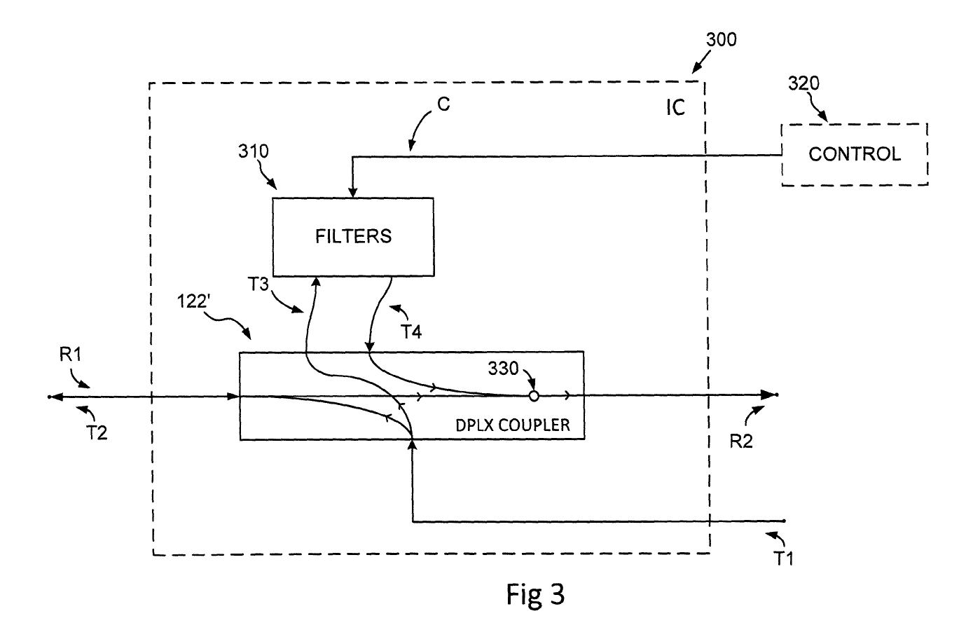

FIG. 3 shows an embodiment of the interference cancellation unit 300 for use with a duplex arrangement like the duplex arrangement 120 shown in FIG. 2. The interference cancellation unit 300 comprises a set of adaptive filters 310 arranged to receive and to filter a second part of the transmit signal T3 to generate a set of filtered transmit signals T4. The interference cancellation unit 300 is also adapted to combine 330 the receive signal R1 which is received from the antenna arrangement 110 with the set of filtered transmit signals T4 to generate the interference suppressed receive signal R2.

It is noted that the combining 330 of the receive signal R1 and filtered transmit signal T4 must be carefully engineered in order to account and possibly compensate for, e.g., signal reflection, matching, and isolation in the duplex coupler 122. Thus, the receive signal R1 and filtered transmit signal T4 cannot be combined in a nave way, e.g., by simple addition, especially in a microwave application.

Signals stemming from the transmit signal T1 can be expected to leak into the interference suppressed receive signal R2 by many different paths and via many different conduits. Part of the leakage between transmit and receive signal can be expect to be via the antenna arrangement 110, possibly comprising a radome adding to the leakage, and also from the surrounding environment, e.g., reflectors such as metal roofs and rain. This leakage of the transmit signal T1 is also likely to be time varying, i.e., the amplitude and phase of the different leakage components can be expected to vary over time in a non-deterministic fashion.

Partly because of this leakage the interference generated in the interference suppressed receive signal R2 is not an exact copy of the transmit signal T1 at any given place in the transmit chain. Rather, the interference originating from the transmit signal T1 can be expected to be a function of the transmit signal T1. A purpose of the above mentioned adaptive filters is to mimic this function and to provide a filtered transmit signal which cancel out or suppresses said interference signal in the interference suppressed receive signal R2.

The set of adaptive filters 310 are arranged to have transfer functions determined by a control signal C. Consequently, the transceiver 200 further comprises a control unit 320, which is adapted to generate the control signal C which is arranged to determine the transfer functions of the set of adaptive filters 310. The generated control signal C has a setting, or a value, which reduces the power of an interference signal comprised in the interference suppressed receive signal R2, which interference signal originates at least in part from the transmit signal T1.

According to an aspect, the control unit 320 is adapted to generate the control signal C to control the transfer functions of the set of adaptive filters 310 to minimize the magnitude of the correlation between the transmit signal T1 and the interference suppressed receive signal R2.

According to an aspect, the set of adaptive filters constitute a single adaptive filter, i.e., the set of filters contain only a single filter.

Consequently, If a duplex arrangement 120 according to the disclosure is analyzed separately, i.e., not used in an actively operating transceiver, using, e.g., a 50 Ohm instrument for measuring coupling between ports of the duplex arrangement, a certain coupling between the port of the transmit signal T1 and the port of the interference suppressed receive signal R2 is likely to be detected, depending of course on the setting of the control signal. At least if the control signal is set for minimum correlation between transmit T1 and interference suppressed receive signal R2 in a complete transceiver 100. The reason being that the duplex arrangement 120 is adapted to suppress a total leakage of the transmit signal T1 into the interference suppressed receive signal R2, and not just the leakage due to a stand-alone duplex arrangement 120.

The manner in which the control unit 320 generates the control signal C varies between different aspects of the disclosure. One example of generating said control signal is to perform a calibration of the transceiver 200 during production or installation, or both. In this case, the near end transceiver is arranged to listen to a known signal transmitted from a far end transceiver while the control signal is swept over a pre-determined range of values. The receiver monitors the received signal quality, i.e., the signal to interference and noise ratio, SINR, and thus determines the control signal setting which gives the highest SINR value to be the control signal of the transceiver.

Another example of generating said control signal C is to continuously update the control signal depending on a detected error signal during operation of the communication system. In one embodiment this error signal is detected by the modem unit 130. In another embodiment this error signal is detected by the duplex arrangement 120. A principle of generating the control signal is to use a least-squares objective function, and to use an update method of the control signal according to a least-mean-squares, LMS, method.

A principle is to compare the detected error signal, which error signal can be determined based on a known received pilot signal or based on a detected payload signal, to a set of reference signals, e.g. comprising the transmit signal T1, and to adjust the control signal accordingly to reduce or to minimize the magnitude of the correlation between detected error signal, or, equivalently, the interference suppressed receive signal R2, and said reference signals. According to other embodiments, other methods, based on e.g., recursive least squares, RLS, or similar is used to determine the control signal setting to minimize or reduce interference in the interference suppressed received signal R2.

According to varying aspects, the control unit 320 is comprised in the duplex arrangement 120, or in the modem unit 130, or distributed throughout the transceiver 200.

In one embodiment, the transmit signal T1 arranged to pass from the duplex arrangement 120 to the antenna arrangement 110, and the receive signal R1 arranged to pass from the antenna arrangement 110 to the duplex arrangement 120 share the same physical interface of the antenna arrangement.

In another embodiment, the transmit signal T1 arranged to pass from the duplex arrangement 120 to the antenna arrangement 110, and the receive signal R1 arranged to pass from the antenna arrangement 110 to the duplex arrangement 120 are transmitted and received via separate physical interfaces of the antenna arrangement 110.

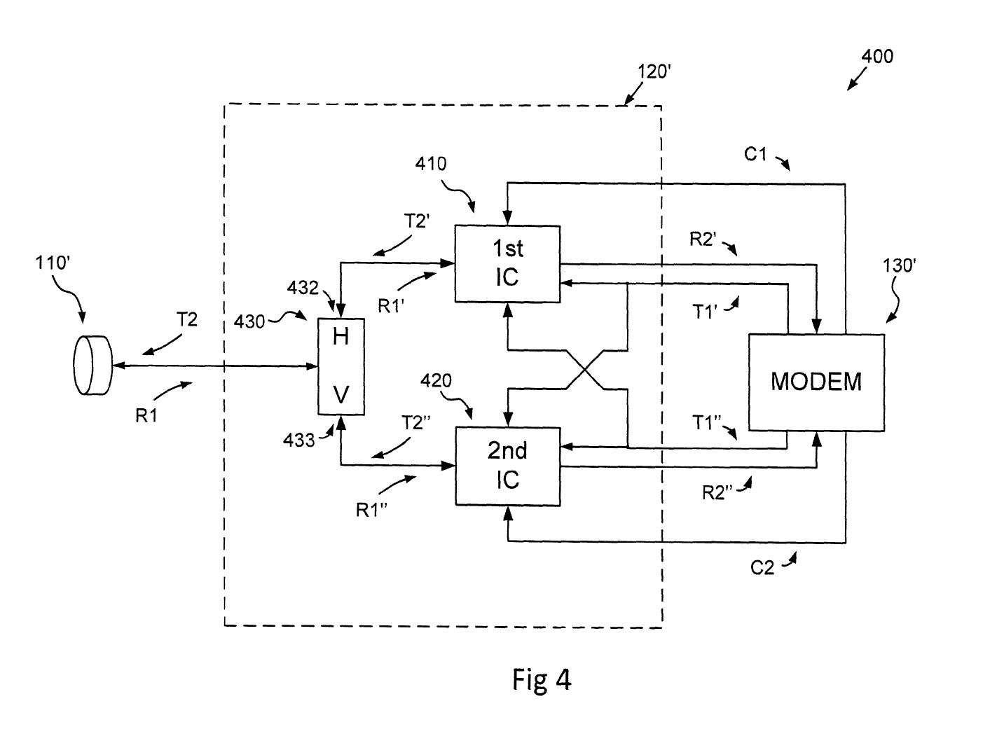

FIG. 4 shows a transceiver 400 with a duplex arrangement 120′ that comprises a polarization diplexer 430. The polarization diplexer 430 is communicatively coupled to the antenna arrangement 110′. The polarization diplexer 430 is arranged to receive a receive signal R1 from the antenna arrangement 110′, and to split the receive signal R1 into horizontal and vertical receive components, as well as to output horizontal and vertical receive components on horizontal 432 and vertical 433 polarization ports as first R1′ and second R1″ receive signals, respectively. The polarization diplexer 430 is further arranged to combine horizontal and vertical transmit components, i.e., the first part of the first transmit signal T2′ and the first part of the second transmit signal T2″ into a single dual-polarized first part of the transmit signal T2 which is forwarded to the antenna arrangement 110′.

The horizontal 432 and vertical 433 polarization ports are connected to first 410 and second 420 interference cancellation units, IC, respectively. The first interference cancellation unit 410 is adapted to receive a first transmit signal T1′ and a second transmit signal T1″ from the modem unit 130′ and to forward a first part of the first transmit signal T2′ to the horizontal polarization port 432. The second interference cancellation unit 420 is also adapted to receive the first transmit signal T1′ and the second transmit signal T1″ from the modem unit 130′ and to forward a first part of the second transmit signal T2″ to the vertical polarization port 433.

As shown in FIG. 4, the first T1′ and second T1″ transmit signals are split prior to being input to the first 410 and second 420 interference cancellation units. Thus, according to this embodiment the first 410 and second 420 interference cancellation units are arranged to receive the same input signals. However, according to an aspect the first T1′ and second T1″ transmit signals are also non-equally attenuated by the splitting, i.e., split in non-equal magnitude components, between interference cancellation units.

The first interference cancellation unit 410 is also adapted to receive the first receive signal R1′ from the horizontal polarization port 432 and to suppress an interference signal comprised in the first receive signal R1′ by processing and combining the first T1′ and second T1″ transmit signal with the first R1′ receive signal to generate a first interference suppressed receive signal R2′. The second interference cancellation unit 420 is adapted to receive the second receive signal R1″ from the vertical polarization port 433 and to suppress an interference signal comprised in the second receive signal R1″ by processing and combining the first T1′ and the second T1″ transmit signal with the second receive signal R1″ to generate a second interference suppressed receive signal R2″. The first 410 and second 420 interference cancellation units are further adapted to forward the first R2′ and the second R2″ interference suppressed receive signals to the modem unit 130′, respectively.

According to an embodiment, the first 410 and second 420 interference cancellation units comprises adaptive filters, which adaptive filters have transfer functions arranged to be controlled by first C1 and second C2 control signals. According to the embodiment shown in FIG. 4, the first C1 and second C2 control signals are generated by a control unit comprised in the modem unit 130′.

The polarization diplexer 430 shown in FIG. 4 is implemented in different ways in different aspects of the disclosure. One example is an implementation where the polarization diplexer 430 comprises an orthomode transducer, OMT.

The polarization diplexer 430 serves to increase the spectral efficiency of a communication system in that it enables transmission and reception on both horizontal and vertical polarization, on the same frequency band. Hence, it is a feature of the disclosure that the present technique of transmitting and receiving simultaneously on at least partly overlapping frequency bands can be combined with transmitting and receiving simultaneously on both horizontal and vertical polarizations. It should be noted that transmit signals T1′, T1“, on one polarization can be expected to change polarization and thus be part of the interference generated in the interference suppressed receive signals R2′, R2”. It is a feature of the embodiment shown in FIG. 4 that such cross-polarization interference is suppressed in the interference suppressed receive signals R2′, R2″.

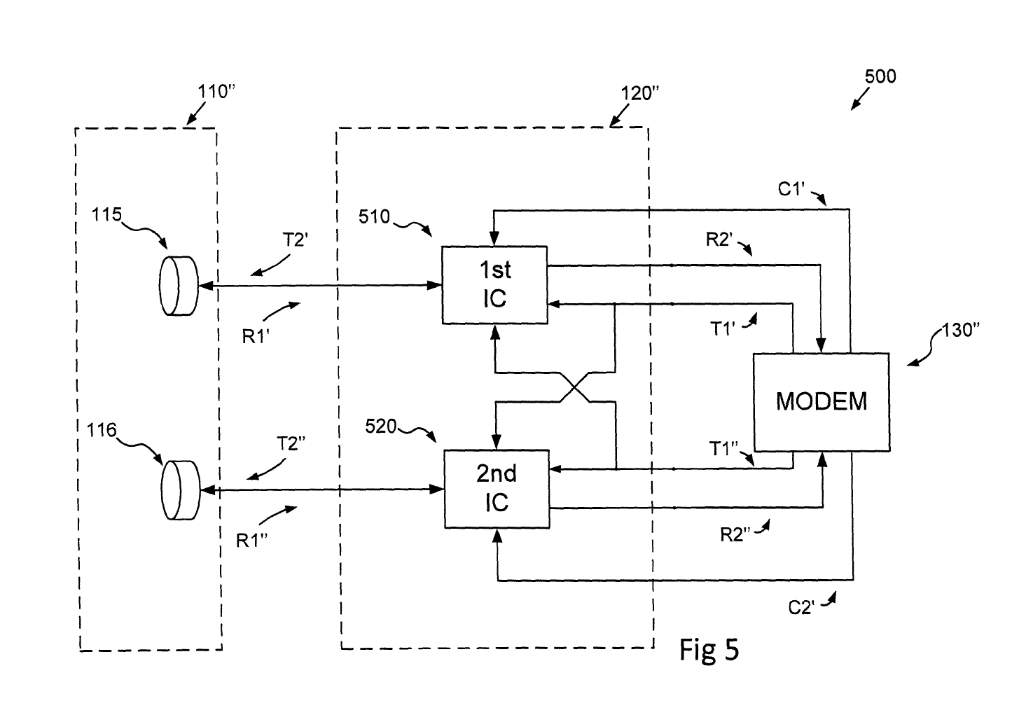

FIG. 5 shows a transceiver 500 wherein the antenna arrangement 110″ comprises first 115 and second 116 antenna units disposed a pre-determined distance apart. The duplex arrangement 120″ comprises first 510 and second 520 interference cancellation units. Each of the first 510 and second 520 interference cancellation units, IC, is adapted to receive a first transmit signal T1′ and also a second transmit signal T1″ from the modem unit 130″. The first interference cancellation unit 510 is adapted to forward a first part of the first transmit signal T2′ to the first antenna unit 115. The second interference cancellation unit 520 is adapted to forward a first part of the second transmit signal T2″ to the second antenna unit 116. Each of the first 510 and second 520 interference cancellation units are also adapted to receive a first R1′ and a second R1″ receive signal from the first 115 and second 116 antenna units, respectively, and to suppress an interference signal in the respective received signal R1′,R1″ by processing and combining the first T1′ and second T1″ transmit signal with the first R1′ or second R1″ receive signal, respectively, to generate a first R2′ and a second R2″ interference suppressed receive signal, respectively.

In one embodiment, the antenna arrangement 110″ is part of a LOS-MIMO antenna arrangement. A transmit signal from one antenna of the antenna arrangement 110″ can be expected to leak into the receive signal coming from the other antenna. According to an aspect of the present disclosure also this leakage is suppressed in the first and second interference suppressed receive signals R2′, R2″ which are output from the interference cancellation units 510, 520. It is a benefit of the present disclosure that embodiments of the disclosed technique can be combined with MIMO antenna arrangements 110″ such as LOS-MIMO antenna arrangements.

According to an aspect, the first 510 and second 520 interference cancellation units shown in FIG. 5 comprises adaptive filters, which adaptive filters have transfer functions arranged to be controlled by first C1′ and second C2′ control signals. According to an embodiment, the first C1′ and second C2′ control signals are generated by a control unit comprised in the modem unit 130″.

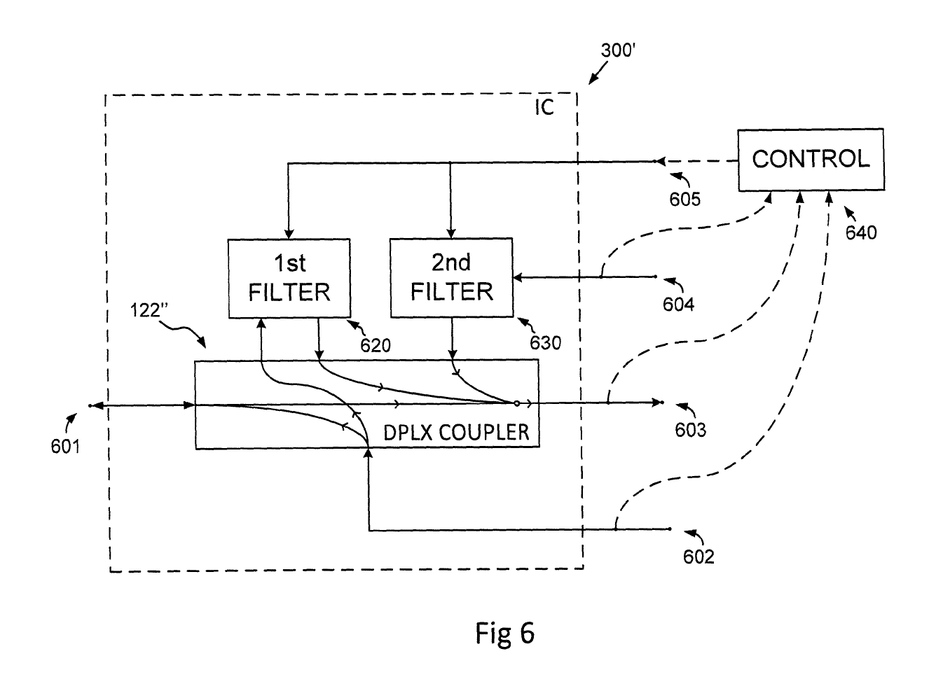

FIG. 6 shows an IC unit 300′ for use with the transceivers 100, 200, 400, 500 described above. The IC unit 300′ comprises an antenna port 601, a transmit port 602, a receive port 603, and a control port 605. The IC unit 300′ also comprises a duplex coupler 122″ and a first adaptive filter 620. The duplex coupler 122″ is arranged to receive a transmit signal from the transmit port 602, and to forward a first part of the transmit signal from the transmit port 602 to the antenna port 601, and to also forward a second part of the transmit signal from the transmit port 602 to an input port of the first adaptive filter 620. The duplex coupler 122″ is also adapted to suppress a coupling between the transmit port 602 and the receive port 603.

By suppressing a coupling between transmit port 602 and receive port 603 is here meant that an interference suppressed signal on the receive port 603 will not contain components stemming from the transmit signal on the transmit port 602, or contain a minimum of components stemming from the transmit signal on the transmit port 602, when the coupler 610 is used in a transceiver 100, 400, 500 according to FIG. 1-3, in a real communication scenario with varying degrees of leakage between transmit and receive signals caused by a plurality of different contributing factors.

Consequently, if a 50 Ohm instrument is used to measure coupling between transmit port 602 and receive port 603, with 50 Ohm termination on the antenna port, a pre-determined degree, determined in part by the control signal, will be measured.

The duplex coupler 122″ shown in FIG. 6 is further arranged to receive a receive signal from the antenna port 601, as well as a first filtered signal from the first adaptive filter 620. The duplex coupler 122″ is arranged to combine the receive signal with the first filtered signal into an interference suppressed receive signal, and to output said interference suppressed receive signal on the receive port 603.

The interference cancellation unit 300′ is also arranged to receive a control signal of the transceiver on the control port 605. The first 620 adaptive filter is arranged to have a transfer function determined by the control signal, the transceiver being adapted to generate a control signal with a setting to minimize an interference in the interference suppressed receive signal originating from the first transmit signal, thus isolating the interference suppressed receive signal on the receive port 603 from the transmit signal on the transmit port 602.

The interference cancellation unit 300′ shown in FIG. 6 also comprises a reference port 604, and a second adaptive filter 630. The second adaptive filter 630 is arranged to receive a second transmit signal on the reference port 604, and to filter said second transmit signal to make a second filtered signal. The duplex coupler 122″ further being arranged to receive the second filtered signal from the second adaptive filter 630, and to combine the receive signal with the first and the second filtered signal into an interference suppressed receive signal, and to output said interference suppressed receive signal on the receive port 603.

The second adaptive filter 630 is arranged to have a transfer function determined by the control signal. The transceiver 100, 200, 400, 500 is adapted to generate a control signal with a value to suppress an interference originating from the second transmit signal in the interference suppressed receive signal.

According to an aspect of the disclosure, the second adaptive filter 630 comprises a filter bank, the filter bank in turn comprising a plurality of adaptive sub-filters. The signal arranged to be received on the reference port 604 then comprises a plurality of sub-reference signals, where each such sub-reference signal is arranged to be an input signal of one out of the plurality of adaptive sub-filters. The control signal being used to determine the transfer function of each of the plurality of adaptive sub-filters to minimize the sum of correlations between interference suppressed receive signal and sub-reference signals.

A purpose of the filter bank is to be able to suppress a plurality of interference components in the interference suppressed receive signal. According to an aspect, the plurality of interference components originate from both transmit and receive signals. I.e., the present disclosure encompasses embodiments where the duplex arrangement is able to perform MIMO processing of a received vector signal.

The first adaptive filter 620 shown in FIG. 6 is according to an embodiment a reflection type filter, wherein the first filtered signal is reflected back from the filter over a common physical interface used for both filter input signal and output filtered signal. The first adaptive filter 620 is further arranged to receive and to filter analog signals, and to output an analog filtered signal.

The first adaptive filter 620 shown in FIG. 6 is according to another embodiment a transmission type filter. In this case the first adaptive filter 620 is arranged to receive an analog signal on a first interface and to filter the analog signal, and to output an analog filtered signal on a second physical interface different from the first physical interface. According to an aspect the second adaptive filter 630 shown in FIG. 6 also comprises a transmission type filter.

According to an aspect, the duplex coupler 122″ comprises at least one delay unit adapted to time align the receive signal with the first filtered signal.

As mentioned above, an embodiment of the interference cancellation unit 300′ comprises a control unit 640 arranged to process first and second transmit signals, as well as the interference suppressed receive signal, and generate a control signal to control the transfer functions of comprised adaptive filters 620, 630.

It should be noted that the signals from the first 620 and the second 630 adaptive filters cannot be combined in a nave way, e.g., by simple addition, especially in a microwave application. Hence, coupling between filters are according to an aspect facilitated by using splitters and combiners or coupling devices.

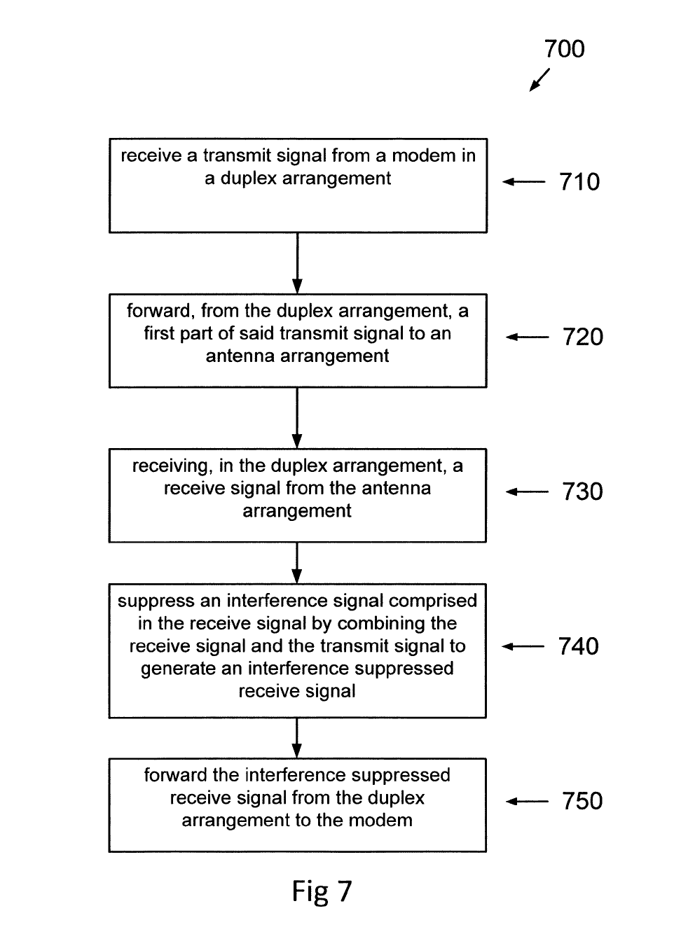

FIG. 7 shows a flowchart of a method 700 for the transmission and reception of communication signals in partly overlapping frequency bands in a MIMO system. The method 700 comprises the steps of;
receiving 710 a transmit signal from a modem in a duplex arrangement,
forwarding 720, from the duplex arrangement, a first part of said transmit signal to an antenna arrangement,
receiving 730, in the duplex arrangement, a receive signal from the antenna arrangement,
suppressing 740 an interference signal comprised in the receive signal by combining the receive signal and the transmit signal to generate an interference suppressed receive signal, which interference signal originate from the transmit signal, the interference suppressed receive signal occupying a first frequency band, the first part of the transmit signal occupying a second frequency band, the first and second frequency bands being at least partly overlapping,
forwarding 750 the interference suppressed receive signal from the duplex arrangement to the modem.

Hence, since interference in the receive signal originating from the transmit signal is suppressed in the interference suppressed receive signal, the first part of the transmit signal and the receive signal can occupy at least partly overlapping frequency bands without the transmit signal causing excessive interference in the receive signal. This increases the spectral efficiency of the MIMO system since previous transmit-only or receive-only frequencies, for one end of a link, can now be used for both transmit and receive signals at the same time.

In an embodiment, the antenna arrangement of the step of receiving 730, shown in FIG. 7, is part of a Line Of Sight, LOS, multiple-input multiple output, MIMO, antenna arrangement. Further, according to an aspect, the transmit signal and the receive signal comprises microwave radio link communication signals.

According to an aspect the step of suppressing 740 also comprises the step of filtering by a set of adaptive filters arranged to receive and to filter a second part of the transmit signal to generate a set of filtered signals, and the step of suppressing 740 further comprises the step of combining the receive signal with the set of filtered signals to generate an interference suppressed receive signal.

In an embodiment, the set of adaptive filters mentioned in connection to FIG. 7 are arranged to have transfer functions determined by a control signal, and the step of suppressing 740 further comprises controlling the transfer functions of the adaptive filters by the control signal to reduce interference in the interference suppressed receive signal originating from the transmit signal. According to an aspect, the transfer functions of the adaptive filters are controlled by the control signal to minimize the magnitude of the correlation between transmit signal and interference suppressed receive signal.

In one embodiment the duplex arrangement of the method 700 comprises a polarization diplexer adapted to split a received dual-polarized signal into horizontal and vertical components, and also to combine horizontal and vertical transmit components into a single dual-polarized transmit signal.

In one embodiment, the antenna arrangement of the method 700 further comprises first and second antenna units disposed a pre-determined distance apart. The step of suppressing 740 then also comprises isolating the interference suppressed receive signal from the transmit signal by using first and second interference cancellation units. The first interference cancellation unit is arranged to receive a first transmit signal from the modem and to forward a first part of the first transmit signal to the first antenna unit. The second interference cancellation unit is arranged to receive a second transmit signal from the modem and to forward a first part of the second transmit signal to the second antenna unit. The first and second interference cancellation units are also adapted to receive a first and a second receive signal from the first and second antenna units, respectively, and to isolate the receive signal from the first transmit signal and the second transmit signal, respectively, prior to forwarding said isolated receive signals to the modem unit as the interference suppressed receive signal.

A main principle of the method 700 of the present disclosure can be understood from considering the duplex arrangement in conjunction with the modem unit and antenna arrangement. In a MIMO system the modem unit generates a plurality of transmit signals, a transmit signal vector, intended for transmission from the different parts of the antenna arrangement. The transmit signal vector can be amplified by amplifiers and can pass any number of other components in the transmit chain which adds noise and distortion to the transmit signals. However, the transmit signal vector is known in the transceiver.

Hence, it is not necessary to use frequency separation and passive filtering in order to separate transmit signal vector from receive signal, as the transmit signals are not unknown noise, but known signals. Instead the transmit vector of the MIMO system can be processed in order to resemble the self-interference in the receive signal vector in amplitude, but be put in opposite phase. Hence, by combining transmit and receive signal vectors this type of self-interference can be suppressed in the MIMO system.

Because interference in the receive signal originating from the transmit signal is suppressed in the interference suppressed receive signal, the transmit and the receive signal can occupy at least partly overlapping frequency bands without the transmit signal causing excessive interference in the receive signal. This permits an increase of the spectral efficiency of the MIMO system since previous transmit and receive frequencies can be used for both transmit and receive signals at the same time.

Aspects of the disclosure are described with reference to the drawings, e.g., block diagrams and/or flowcharts. It is understood that several entities in the drawings, e.g., blocks of the block diagrams, and also combinations of entities in the drawings, can be implemented by computer program instructions, which instructions can be stored in a computer-readable memory, and also loaded onto a computer or other programmable data processing apparatus. Such computer program instructions can be provided to a processor of a general purpose computer, a special purpose computer and/or other programmable data processing apparatus to produce a machine, such that the instructions, which execute via the processor of the computer and/or other programmable data processing apparatus, create means for implementing the functions/acts specified in the block diagrams and/or flowchart block or blocks.

In some implementations and according to some aspects of the disclosure, the functions or steps noted in the blocks can occur out of the order noted in the operational illustrations. For example, two blocks shown in succession can in fact be executed substantially concurrently or the blocks can sometimes be executed in the reverse order, depending upon the functionality/acts involved. Also, the functions or steps noted in the blocks can according to some aspects of the disclosure be executed continuously in a loop.

In the drawings and specification, there have been disclosed exemplary aspects of the disclosure. However, many variations and modifications can be made to these aspects without substantially departing from the principles of the present disclosure. Thus, the disclosure should be regarded as illustrative rather than restrictive, and not as being limited to the particular aspects discussed above. Accordingly, although specific terms are employed, they are used in a generic and descriptive sense only and not for purposes of limitation.

1. A transceiver for simultaneous transmission and reception of communication signals in a multiple-input multiple-output (MIMO) system, the transceiver comprising:
an antenna arrangement,
a duplex arrangement, and
a modem unit,
the duplex arrangement being adapted to receive a transmit signal from the modem unit, transmit a first part of the transmit signal to the antenna arrangement, and receive a receive signal from the antenna arrangement,
the duplex arrangement comprising an interference cancellation (IC) unit adapted to generate an interference suppressed receive signal by combining the receive signal and the transmit signal, and
the duplex arrangement being further adapted to transmit the interference suppressed receive signal to the modem unit.

2. The transceiver of claim 1, wherein the receive signal occupying a first frequency band, the first part of the transmit signal occupying a second frequency band, and wherein the first and second frequency bands are at least partly overlapping, the transceiver thus being arranged to simultaneously transmit and receive communication signals in a MIMO system on at least partly overlapping frequency bands.

3. The transceiver of claim 1, wherein the antenna arrangement is part of a Line Of Sight (LOS) multiple-input multiple output (MIMO) antenna arrangement, and wherein the transmit and receive signals comprises a plurality of data streams, arranged to be transmitted over a plurality of LOS-MIMO channels.

4. The transceiver of claim 1, wherein the IC unit comprises at least one duplex coupler arranged to connect the antenna arrangement to at least one modulator and at least one demodulator comprised in the modem unit, the duplex coupler being arranged to forward part of the transmit signal from the at least one modulator to the antenna arrangement as the first part of the transmit signal, and also to forward the receive signal from the antenna arrangement to the at least one demodulator as the interference suppressed receive signal, wherein the interference suppressed receive signal is arranged to be isolated from the transmit signal.

5. The transceiver of claim 1, wherein
the IC unit comprises a set of adaptive filters arranged to receive and to filter a second part of the transmit signal received from the modem unit to generate a set of filtered transmit signals,
the IC unit further being adapted to combine the receive signal with the set of filtered transmit signals to generate the interference suppressed receive signal,
the set of adaptive filters being arranged to have transfer functions determined by a control signal,
the transceiver further comprising a control unit adapted to generate the control signal, which control signal is arranged to determine the transfer functions of the set of adaptive filters, the control signal having a setting to reduce the power of an interference signal comprised in the interference suppressed receive signal, and
said interference signal originating at least in part from the transmit signal.

6. The transceiver of claim 5, wherein the adaptive filters are arranged to receive and to filter a second part of the transmit signal received from the modem unit via the duplex coupler.

7. The transceiver of claim 1, wherein
the duplex arrangement comprises a polarization diplexer connected to the antenna arrangement,
the polarization diplexer being arranged to receive the receive signal from the antenna arrangement, and to split the receive signal into horizontal and vertical receive components, as well as to output horizontal and vertical receive components on horizontal and vertical polarization ports as first and second receive signals, respectively,
the horizontal and vertical polarization ports being connected to first and second IC units, respectively,
the first IC unit being adapted to receive a first transmit signal and a second transmit signal from the modem unit and to forward a first part of the first transmit signal to the horizontal polarization port,
the second IC unit also being adapted to receive the first transmit signal and the second transmit signal from the modem unit and to forward a first part of the second transmit signal to the vertical polarization port,
the first IC unit being adapted to receive the first receive signal from the horizontal polarization port and to generate a first interference suppressed receive signal by processing and combining the first and second transmit signal with the first receive signal,
the second IC unit being adapted to receive the second receive signal from the vertical polarization port and to generate a second interference suppressed receive signal by processing and combining the first and second transmit signal with the second receive signal, and
the first and second IC units further being adapted to forward said first and second interference suppressed receive signals, respectively, to the modem unit.

8. The transceiver of claim 1, wherein the antenna arrangement comprises first and second antenna units disposed a pre-determined distance apart, the duplex arrangement comprising first and second IC units, the first and second IC unit being adapted to receive a first transmit signal and a second transmit signal, respectively, from the modem unit, the first IC unit being adapted to forward a first part of the first transmit signal to the first antenna unit, the second IC unit being adapted to forward a first part of the second transmit signal to the second antenna unit, the first IC unit being adapted to receive a first receive signal from the first antenna unit and to generate a first interference suppressed receive signal by processing and combining the first transmit signal with the first receive signal, the second IC unit being adapted to receive a second receive signal from the second antenna unit and to generate a second interference suppressed receive signal by processing and combining the first transmit signal with the second receive signal, the first and second IC units further being adapted to forward said first and second interference suppressed receive signals to the modem unit, respectively, said interference signals originating from the first and second transmit signal.

9. The transceiver of claim 8, wherein the first and second IC units are arranged to receive also the second and the first transmit signal, respectively, and to suppress an interference signal by processing and combining the second transmit signal with the first receive signal and the first transmit signal with the second receive signal, respectively, to generate the first and the second interference suppressed receive signal, respectively.

10. The transceiver of claim 1, wherein the first part of the transmit signal arranged to pass from the duplex arrangement to the antenna arrangement, is passed over the same physical interface as the receive signal arranged to pass from the antenna arrangement to the duplex arrangement interface to the antenna arrangement.

11. The transceiver of claim 1, wherein the first part of the transmit signal arranged to pass from the duplex arrangement to the antenna arrangement, and the receive signal arranged to pass from the antenna arrangement to the duplex arrangement are transmitted and received via separate physical interfaces to the antenna arrangement.

12. The transceiver of claim 11, wherein the IC unit comprises an antenna port, a transmit port, a receive port, and a control port, the IC unit further comprising a duplex coupler, and a first adaptive filter, the duplex coupler being arranged to receive a transmit signal on the transmit port, and to forward a first part of the transmit signal from the transmit port to the antenna port, and to forward a second part of the transmit signal from the transmit port to an input port of the first adaptive filter, the duplex coupler being adapted to suppress coupling between transmit port and receive port, the duplex coupler further being arranged to receive a receive signal from the antenna port, and a first filtered signal from the first adaptive filter, the duplex coupler being arranged to combine the receive signal with the first filtered signal into an interference suppressed receive signal, and to output said interference suppressed receive signal on the receive port, the IC unit further being arranged to receive a control signal of the transceiver on the control port, the first adaptive filter being arranged to have a transfer function determined by the control signal, the transceiver being adapted to generate a control signal with a setting to minimize an interference in the interference suppressed receive signal originating from the transmit signal, thus isolating the interference suppressed receive signal on the receive port from the transmit signal on the transmit port.

13. The transceiver of claim 12, wherein the IC unit further comprises a reference port, and a second adaptive filter, the second adaptive filter being arranged to receive a second transmit signal on the reference port, and to filter said second transmit signal to make a second filtered signal, the duplex coupler further being arranged to receive the second filtered signal from the second adaptive filter, and to combine the receive signal with the first and the second filtered signal into an interference suppressed receive signal, and to output said interference suppressed receive signal on the receive port, the second adaptive filter being arranged to have a transfer function determined by the control signal, the transceiver being adapted to generate a control signal with a value to suppress an interference originating from the second transmit signal in the interference suppressed receive signal.

14. The transceiver of claim 13, wherein the second adaptive filter comprises a filter bank, the filter bank in turn comprising a plurality of adaptive sub-filters, and wherein the signal arranged to be received on the reference port comprises a plurality of sub-reference signals, where each such sub-reference signal is arranged to be an input signal of one out of the plurality of adaptive sub-filters, the control signal being used to determine the transfer function of each of the plurality of adaptive sub-filters to minimize the sum of correlations between interference suppressed receive signal and sub-reference signals.

15. The transceiver of claim 12, wherein the first adaptive filter comprises a reflection type filter, wherein the first filtered signal is reflected back from the filter over a common physical interface used for both filter input signal and output filtered signal, the first adaptive filter being arranged to receive and to filter analog signals, and to output an analog filtered signal.

16. The transceiver of claim 12, in which the first adaptive filter comprises a transmission type filter, the first adaptive filter being arranged to receive an analog signal on a first interface and to filter the analog signal, and to output an analog filtered signal on a second physical interface different from the first physical interface.

17. The transceiver of claim 1, wherein the antenna arrangement comprises first and second antenna units disposed a pre-determined distance apart, the first and second antenna unit being arranged to have directive radiation patterns focused in a first and a second pre-determined direction, the IC unit 121 being adapted to combine the transmit signal and the receive signal by forwarding the transmit signal to the first antenna and forwarding a receive signal received at the second antenna unit from the second antenna unit to the modem unit, wherein said combining is via signal propagation of the transmit signal from the first antenna to the second antenna.

18. A method for the transmission and reception of communication signals in partly overlapping frequency bands in a multiple-input multiple output (MIMO) system, the method comprising:
receiving a transmit signal from a modem in a duplex arrangement,
forwarding, from the duplex arrangement, a first part of said transmit signal to an antenna arrangement,
receiving, in the duplex arrangement, a receive signal from the antenna arrangement,
suppressing an interference signal comprised in the receive signal by combining the receive signal and the transmit signal to generate an interference suppressed receive signal, which interference signal originates from the transmit signal, the interference suppressed receive signal occupying a first frequency band, the first part of the transmit signal occupying a second frequency band, the first and second frequency bands being at least partly overlapping, and
forwarding the interference suppressed receive signal from the duplex arrangement to the modem.

19. The method of claim 18, wherein the step of suppressing further comprises the step of filtering by a set of adaptive filters arranged to receive and to filter a second part of the transmit signal to generate a set of filtered signals, the step of suppressing also comprising the step of combining the receive signal with the set of filtered signals prior to generate an interference suppressed receive signal.

20. The method of claim 18, wherein the duplex arrangement comprises a polarization diplexer adapted to split a received dual-polarized signal into horizontal and vertical components prior to the step of suppressing, and to combine horizontal and vertical transmit components into a single dual-polarized transmit signal prior to the step of forwarding the first part of the transmit signal to the antenna arrangement.

21. The method of claim 18, wherein the antenna arrangement comprises first and second antenna units disposed a pre-determined distance apart, and wherein the step of suppressing comprises isolating the interference suppressed receive signal from the transmit signal by using first and second IC units, the first and second IC units being adapted to receive a first and a second transmit signal from the modem, respectively, the first and second IC units being adapted to forward a first part of the first and a first part of the second transmit signal, respectively, to the first and second antenna units, respectively, the first and second IC units further being adapted to receive a first and a second receive signal, respectively, from the first and second antenna units, respectively, and to isolate the first and second receive signal from the first and second transmit signal, respectively, prior to forwarding said isolated receive signals to the modem unit as first and second interference suppressed receive signals, respectively.
